(19) United States
(12) Patent Application Publication
(10) Pub. No.: US 2024/0196813 A1
(43) Pub. Date: Jun. 20, 2024

(54) FAN-EQUIPPED GROW LIGHT

(71) Applicant: Sinowell (Shanghai) Co., Ltd., Shanghai (CN)

(72) Inventors: Jia LUO, Shanghai (CN); Yunfei DUAN, Shanghai (CN); Liang ZHOU, Shanghai (CN)

(21) Appl. No.: 17/913,701

(22) PCT Filed: Jun. 23, 2022
(86) PCT No.: PCT/CN2022/100699

§ 371 Date: Sep. 22, 2022

(30) Foreign Application Priority Data
May 11, 2022 (CN) 202210513790.8
May 11, 2022 (CN) 202221134091.4

(51) Int. Cl. A01G 9/24; F21V 33/00

(52) U.S. Cl. CPC A01G 9/246; A01G 9/249; F21V 33/0096

(57) ABSTRACT

Provided is a fan-equipped grow light. The fan-equipped grow light includes a fan assembly and a light panel assembly. The fan assembly includes a fan configured to promote air circulation. The light panel assembly includes a first mounting panel and second mounting panels. The fan is connected to the first mounting panel. The second mounting panels include a plurality of frame structures sleeved at intervals in sequence. A plurality of second mounting panels are disposed around the first mounting panel and are securely connected to the first mounting panel. Lights are disposed on the panel surface of the first mounting panel and the panel surfaces of the second mounting panels.

### CROSS-REFERENCE TO RELATED APPLICATION(S)

This is a national stage application filed under 35 U.S.C. 371 based on International Patent Application No. PCT/CN2022/100699, filed Jun. 23, 2022, which claims priority to Chinese Patent Application No. 202210513790.8 filed with the China National Intellectual Property Administration (CNIPA) on May 11, 2022 and Chinese Patent Application No. 202221134091.4 filed with the CNIPA on May 11, 2022, the disclosures of which are incorporated herein by reference in their entireties.

### TECHNICAL FIELD

The present application relates to the field of grow light technology, for example, a fan-equipped grow light.

### BACKGROUND

A grow light is applied to plants and used for simulating sunlight required by the plants to supplement light to the plants or completely replace sunlight, thereby promoting photosynthesis of the plants. A grow light is very suitable for plant growth, flowering and fruiting. In general, indoor plants and flowers grow worse and worse over time due to a lack of natural light. In this case, a grow light with a spectrum required by the plants is used to not only promote the growth of the plants, but also prolong the flowering period and improve the quality of the flowers. A grow light has many advantages. For example, as artificial supplementary light, the grow light can prolong effective lighting time; lighting is not affected by weather; and a spectrum is adjusted according to the requirements of plants.

For plants grown in an indoor environment such as a greenhouse or a tent, due to the poor indoor air circulation, a fan needs to be mounted to promote air circulation to promote plant growth. However, for a fan-equipped grow light in the related art, a light panel is a flat panel. The center of the light panel is formed with a mounting hole for mounting a fan. Multiple light beads are densely arranged on the light panel. The light panel is heavy, and light sources cannot be reasonably arranged. The light sources are relatively concentrated, and the lighting area is small. As a result, it is difficult to achieve an ideal lighting effect.

Therefore, there is an urgent need to provide a fan-equipped grow light to solve the preceding problems.

### SUMMARY

The present application provides a fan-equipped grow light that is lightweight and can provide a large lighting area.

The present application adopts the technical solution below.

A fan-equipped grow light includes a fan assembly and a light panel assembly.

The fan assembly includes a fan configured to promote air circulation.

The light panel assembly includes a first mounting panel and second mounting panels. The fan is connected to the first mounting panel. The second mounting panels include a plurality of frame structures sleeved at intervals in sequence. A plurality of second mounting panels are disposed around the first mounting panel and are securely connected to the first mounting panel. Lights are disposed on the panel surface of the first mounting panel and the panel surfaces of the second mounting panels.

### BRIEF DESCRIPTION OF DRAWINGS

FIG. 1 is a view illustrating the structure of a fan-equipped grow light according to the present application.

FIG. 2 is a view illustrating the structure of a light panel assembly according to the present application.

FIG. 3 is a top view of the light panel assembly according to the present application.

FIG. 4 is an exploded view of a fan assembly according to the present application.

### REFERENCE LIST

100 fan assembly
110 fan
120 flow guide casing
130 flow guide blade
140 mesh cover
150 bolt
200 light panel assembly
210 first mounting panel
211 extension panel
212 connecting panel
220 second mounting panel
230 light

### DETAILED DESCRIPTION

In the description of the present application, it is to be noted that orientations or position relations indicated by terms such as “center”, “upper”, “lower”, “left”, “right”, “vertical”, “horizontal”, “in”, and “out” are orientations or position relations based on the drawings. These orientations or position relations are intended only to facilitate the description of the present application and simplify the description and not to indicate or imply that a device or element referred to must have such orientations or must be configured or operated in such orientations. Thus, these orientations or position relations are not to be construed as limiting the present application. In addition, terms such as “first” and “second” are used only for the purpose of description and are not to be construed as indicating or implying relative importance. Terms “first position” and “second position” are two different positions. Moreover, when the first feature is described as “on”, “above”, or “over” the second feature, the first feature is right on, above, or over the second feature or the first feature is obliquely on, above, or over the second feature, or the first feature is simply at a higher level than the second feature. When the first feature is described as “under”, “below”, or “underneath” the second feature, the first feature is right under, below, or underneath the second feature or the first feature is obliquely under, below, or underneath the second feature, or the first feature is simply at a lower level than the second feature.

In the description of the present disclosure, it is to be noted that unless otherwise expressly specified and limited, the term “mounted”, “connected to each other” or “connected” should be construed in a broad sense as securely connected, detachably connected or integrally connected; mechanically connected or electrically connected; directly connected to each other or indirectly connected to each other via an intermediary; or intraconnected between two components. For those of ordinary skill in the art, meanings of the preceding terms in the present application may be construed according to circumstances.

Embodiments of the present application are described in detail below, and examples of the embodiments are illustrated in the drawings, where the same or similar reference numerals indicate the same or similar elements or elements having the same or similar functions. The embodiments described below with reference to the drawings are illustrative and only for explaining the present application and not to be construed as limiting the present application.

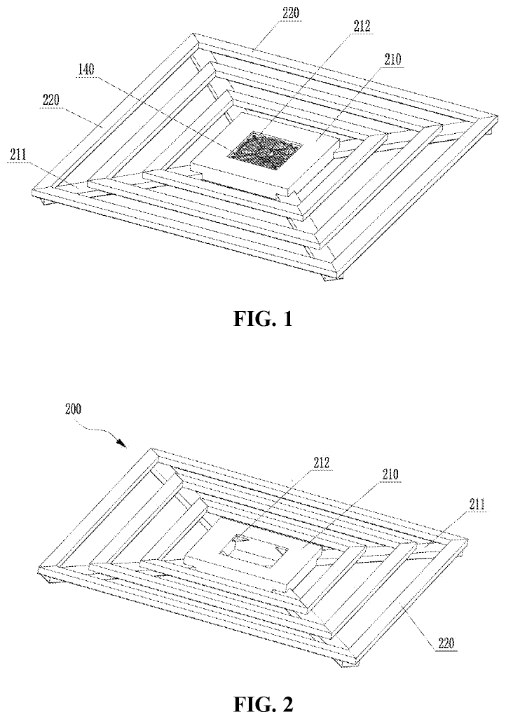

Referring to FIGS. 1 to 4, an embodiment provides a fan-equipped grow light. The fan-equipped grow light includes a fan assembly 100 and a light panel assembly 200. The fan assembly 100 includes a fan 110 configured to promote air circulation. The light panel assembly 200 includes a first mounting panel 210 and second mounting panels 220. The fan 110 is connected to the first mounting panel 210. The second mounting panels 220 include a plurality of frame structures sleeved at intervals in sequence. A plurality of second mounting panels 220 are disposed around the first mounting panel 210 and are securely connected to the first mounting panel 210. Lights 230 are disposed on the panel surface of the first mounting panel 210 and the panel surfaces of the second mounting panels 220.

In the preceding fan-equipped grow light, the fan 110 is integrated with lights 230. The fan-equipped grow light is applied in an indoor environment such as a grow tent and can promote the air circulation of a plant growth environment. In this manner, plants breathe better, and the growth of molds is inhibited. Moreover, light is provided for the plants to promote photosynthesis to promote plant growth. The first mounting panel 210 is disposed, and the fan 110 is connected to the first mounting panel 210. In this manner, the fan 110 is combined with the lights 230. Since the second mounting panels 220 include a plurality of frame structures sleeved at intervals, the overall structure is lightweight. Compared with a light panel of a flat-panel structure in the related art, the plurality of frame structures enable dispersed light sources to expand the light area. Thus, the number of fan lights in a greenhouse can be appropriately reduced, and the cost is reduced.

Referring to FIGS. 1 to 3, the first mounting panel 210 is a frame structure. The fan 110 is disposed in the center of the first mounting panel 210. An extension panel 211 is connected to the outer sidewall of the first mounting panel 210. The second mounting panels 220 are connected to the extension panel 211. For example, the first mounting panel 210 is a square frame structure. The fan 110 is disposed in the inner frame of the square. Of course, the first mounting panel 210 may also be an annular structure. The fan 110 is disposed in the inner ring of the annular structure. The extension panel 211 is connected to the outer ring of the annular structure.

For example, a plurality of extension panels 211 are disposed. The extension panels 211 are radially arranged. In this embodiment, four extension panels 211 are disposed and are connected to the corners of the first mounting panel 210. In other embodiments, the extension panels 211 may also be connected to the straight edges of the first mounting panel 210, and the number of the extension panels 211 may be configured as required, for example, two, six or eight. For example, an extension panel 211 is a strip structure. The extension panels 211 enable a stable connection between the first mounting panel 210 and the second mounting panels 220. For example, the second mounting panels 220 are connected to the upper sides of the extension panels 211 so that lights 230 can be disposed on the extension panels 211 to increase the number of arranged lights 230 and improve the light effect.

For example, the plurality of frame structures of the second mounting panels 220 are located on the same horizontal plane. The extension panels 211 are disposed in parallel with the first mounting panel 210. In other embodiments, an included angle may be formed between the extension panels 211 and the first mounting panel 210. The plurality of frame structures of the second mounting panels 220 are disposed in parallel, but on different horizontal planes.

For example, a second mounting panel 220 is a frame structure. The second mounting panels 220 and the first mounting panel 210 are concentrically disposed. In this embodiment, a second mounting panel 220 is also a square frame structure. Multiple second mounting panels 220 are disposed. The size of the second mounting panel 220 closest to the first mounting panel 210 is the smallest, and the sizes of the multiple second mounting panels 220 gradually increase from an inner ring to an outer ring. In other embodiments, a second mounting plate may also be annular. Multiple annular structures are concentrically disposed.

For example, the first mounting panel 210, the second mounting panels 220 and the extension panels 211 may be integrally formed and may also be assembled and formed by splicing. The light panel assembly 200 of a frame structure not only increases the space for arranging the lights 230, but also reduces the overall weight of the structure, thereby implementing lightweight.

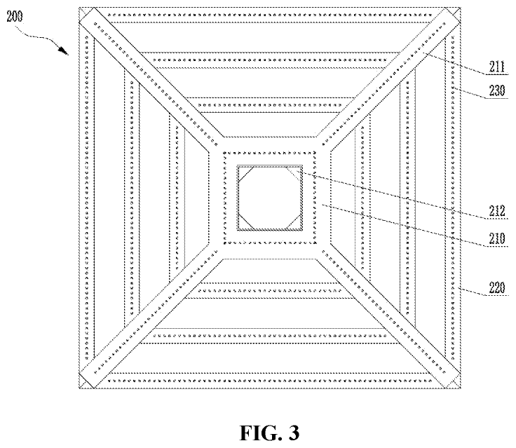

Referring to FIG. 3, the lights 230 include multiple light beads disposed at intervals. The lights 230 are disposed on the bottom surfaces of the first mounting panel 210, the second mounting panels 220 and the extension panels 211 so that light sources face plants below the light sources. In other embodiments, the light sources may be disposed according to the requirements of the plants. The type and structure of a light 230 are mature related arts and are not detailed here.

Referring to FIGS. 2 and 3, to facilitate the mounting of the fan assembly 100, in this embodiment, connecting panels 212 are disposed on the inner frame of the first mounting panel 210, and the fan assembly 100 is connected to the connecting panels 212. The connecting panels 212 are disposed at four corners of the inner frame of the first mounting plate. The cross section of a connecting panel 212 is triangular, so the mounting and function of the fan 110 are not affected. In other embodiments, the connecting panels 212 may be designed according to the structure of the first mounting plate as long as the fan assembly 100 can be connected.

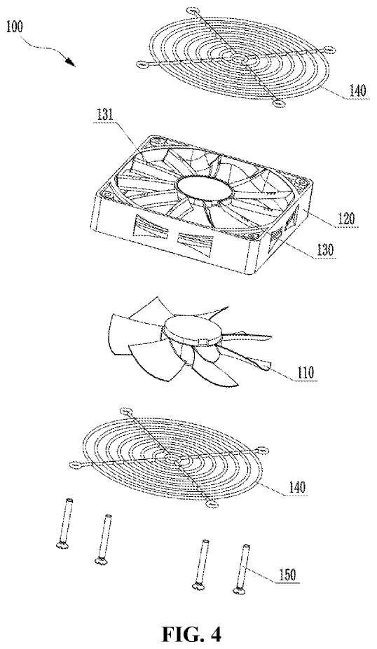

For example, referring to FIG. 4, the fan assembly 100 also includes a flow guide casing 120. The fan 110 is disposed in the flow guide casing 120 and connected to the flow guide casing 120. The flow guide casing 120 is securely connected to the first mounting panel 210. For example, the inner ring of the flow guide casing 120 is cylindrical, and the inner diameter of the inner ring is configured according to the diameter of the fan 110. The outer ring of the flow guide casing 120 is square, and the size of the outer ring is configured according to the size of the inner frame of the first mounting plate. In one aspect, the flow guide casing 120 facilitates the assembly of the fan 110 and the light panel assembly 200. In another aspect, the flow direction of an air flow can be guided, and the circulation effect of air is improved.

For example, a mesh cover 140 is disposed on at least one of the air inflow side of the fan 110 or the air outflow side of the fan 110. The mesh cover 140 is securely connected to the flow guide casing 120. The mesh cover 140 is a mesh structure and includes multiple rings that are concentrically disposed and connecting ribs. The multiple rings are sleeved and gradually increase in size from an inner ring to an outer ring. The multiple rings are disposed on the same horizontal plane. The connecting ribs are radially disposed and securely connect all the rings. In this embodiment, seven rings are disposed. In other embodiments, five, six or eight rings may be disposed. In this embodiment, four connecting ribs are disposed and form a cross-shaped structure. The end of each connecting rib is provided with a mounting ring configured to be connected to the flow guide casing 120. In other embodiments, three, five or six connecting ribs may be disposed as long as the multiple rings can be securely connected. For example, the connecting ribs and the rings may be integrally formed and may also be securely connected by welding or in other manners. In this embodiment, the multiple rings are disposed on the same horizontal plane, and multiple connecting ribs are linear and disposed on the same horizontal plane. In other embodiments, the multiple rings may be disposed on different horizontal planes, and the connecting ribs are configured to be curved according to the arrangement of the rings. The mesh cover 140 disposed on the air inflow side of the fan 110 allows air to flow to fan blades through the gaps in the mesh cover 140 to supplement air, and the wind generated by the rotation of the fan blades blows downwards. The mesh cover 140 on the air outflow side can perform second acceleration on the wind, adjust an air outflow duct of the fan 110 and improve the effect of the fan 110 in promoting air circulation.

For example, a plurality of flow guide blades 130 are disposed in the flow guide casing 120. Each flow guide blade 130 is provided with serrations. The flow guide blades 130 and the serrations can interfere with and eliminate the air turbulence at the periphery of the fan blades, thereby reducing the noise caused by the high-frequency flutter of the fan 110. The shape and the number of the flow guide blades 130 and the shape and the number of the serrations may be configured according to actual requirements. The structural design of the flow guide blades 130 and the serrations is a mature related art and is not detailed here.

In this embodiment, the fan assembly 100 also includes bolts 150. Four bolts 150 are disposed. Four corners of the flow guide casing 120 are provided with through holes extending in a vertical direction. The position of a through hole is disposed opposite to the position of a mounting ring of the mesh cover 140. A bolt 150 sequentially passes through a mounting ring of the mesh cover 140 on the air inflow side, a through hole of the flow guide casing 120 and a mounting ring of the mesh cover 140 on the air outflow side and is secured to a connecting panel 212 of the first mounting plate. The fan assembly 100 and the light panel assembly 200 are assembled using the bolts 150. In this manner, the connection is convenient, and the structure is simple.

In the fan-equipped grow light provided by the present application, the fan is integrated with the lights. The fan-equipped grow light is applied in the indoor environment such as a grow tent and can promote the air circulation of the plant growth environment. In this manner, the plants breathe better, the growth of molds is inhibited. Moreover, light is provided for the plants to promote the photosynthesis to promote the plant growth. The first mounting panel is disposed, and the fan is connected to the first mounting panel. In this manner, the fan is combined with the lights. Multiple second mounting panels are disposed around the first mounting panel, and the multiple second mounting panels are disposed at intervals. In this manner, the area of light sources can be increased. Moreover, the weight of the light panel assembly is relatively light, and more arrangement space is provided for the disposition of the lights. Thus, the number of fan lights in the greenhouse can be appropriately reduced, and the production cost is reduced.

1. A fan-equipped grow light, comprising:
a fan assembly comprising a fan configured to promote air circulation; and
a light panel assembly comprising a first mounting panel and second mounting panels, wherein the fan is connected to the first mounting panel, the second mounting panels comprise a plurality of frame structures sleeved at intervals in sequence, the second mounting panels are disposed around the first mounting panel and are securely connected to the first mounting panel, and lights are disposed on a panel surface of the first mounting panel and panel surfaces of the second mounting panels.

2. The fan-equipped grow light according to claim 1, wherein the first mounting panel is a frame structure, the fan is disposed in a center of the first mounting panel, an extension panel is connected to an outer sidewall of the first mounting panel, and the second mounting panels are connected to the extension panel.

3. The fan-equipped grow light according to claim 2, wherein a plurality of extension panels are disposed, and the plurality of extension panels are radially arranged.

4. The fan-equipped grow light according to claim 2, wherein a light is disposed on the extension panel.

5. The fan-equipped grow light according to claim 1, wherein the plurality of frame structures of the second mounting panels are located on a same horizontal plane.

6. The fan-equipped grow light according to claim 1, wherein an inner frame of the first mounting panel is connected to a connecting panel, and the fan assembly is connected to the connecting panel.

7. The fan-equipped grow light according to claim 1, wherein the fan assembly further comprises a flow guide casing, the fan is disposed in the flow guide casing and connected to the flow guide casing, and the flow guide casing is securely connected to the first mounting panel.

8. The fan-equipped grow light according to claim 7, wherein a mesh cover is disposed on at least one of an air inflow side of the fan or an air outflow side of the fan, and the mesh cover is securely connected to the flow guide casing.

9. The fan-equipped grow light according to claim 7, wherein a plurality of flow guide blades are disposed in the flow guide casing.

10. The fan-equipped grow light according to claim 9, wherein each of the flow guide blades is formed with a serration.

11. The fan-equipped grow light according to claim 8, wherein a plurality of flow guide blades are disposed in the flow guide casing.

12. The fan-equipped grow light according to claim 11, wherein each of the flow guide blades is formed with a serration.
